(19) United States
(12) Patent Application Publication
(10) Pub. No.: US 2022/0027832 A1
(43) Pub. Date: Jan. 27, 2022

(54) METHODS, SYSTEMS, DEVICES, AND COMPUTER-READABLE STORAGE MEDIUM FOR INFORMATION PROCESSING

(71) Applicant: BEIJING DIDI INFINITY TECHNOLOGY AND DEVELOPMENT CO., LTD., Beijing (CN)

(72) Inventor: Feng BAO, Beijing (CN)

(73) Assignee: BEIJING DIDI INFINITY TECHNOLOGY AND DEVELOPMENT CO., LTD., Beijing (CN)

(21) Appl. No.: 17/311,343

(22) PCT Filed: Dec. 6, 2019
(86) PCT No.: PCT/CN2019/123594

§ 371 Date: Jun. 6, 2021

(30) Foreign Application Priority Data
Dec. 6, 2018 (CN) 201811488433.0

(51) Int. Cl. G06Q 10/06

(52) U.S. Cl. CPC G06Q 10/063112; G06Q 10/0639; G06Q 10/06315

(57) ABSTRACT

The present disclosure discloses a method, a system, a device, and a computer-readable storage medium for information processing. The method may include: obtaining a help request transmitted by a user terminal, the help request being in response to an event associated with a user; determining a first service provider from a candidate service provider set based on the help request, the first service provider having an ability to arrive at a location where the event happens within a preset time period and handle the event; generating a first help order associated with the help request; and transmitting the first help order to a first terminal associated with the first service provider. The method of the present disclosure may dispatch a rescue order online, thereby improving the accuracy for dispatching the rescue order and the efficiency for rescue. Through dispatching serial rescue orders by obtaining feedback information of the service provider, the rescue order may be dispatched more accurately and a cost for human labor may be reduced.

### CROSS-REFERENCE TO RELATED APPLICATIONS

This application claims priority to Chinese Application No. 201811488433.0, filed on Dec. 6, 2018, the contents of which are hereby incorporated by reference in its entirety.

### TECHNICAL FIELD

The present disclosure relates to technical fields of public transport services, and more particularly to methods, systems, devices, and computer-readable storage media for information processing.

### BACKGROUND

With the continuous expansion of a taxi service industry based on a network platform, a vehicle malfunction, a vehicle accident, and a conflict between a driver and a passenger are also increased. When the driver or the passenger calls the platform for help via a phone, the platform may guide through the phone. However, the driver or the passenger more hopes that there may be someone to arrive at the scene, such that the event may be handled more accurately. Since an emergency may happen all over a city, the time cost of an on-site rescue may be greatly increased, and the best time to rescue may be missed. Therefore, it is desirable to provide information processing methods and systems for handing the emergency all over the city more efficiently.

### SUMMARY

The present disclosure may mainly involve methods, systems, devices, and computer-readable storage media for information processing of rescuing and handing emergencies all over a city more efficiently. Specifically, the present disclosure may provide the following aspects.

In a first aspect, the present disclosure may disclose an information processing method. The method may include: obtaining a help request transmitted by a user terminal, the help request being in response to an event associated with a user; determining a first service provider from a candidate service provider set based on the help request, the first service provider having an ability to arrive at a location where the event happens within a preset time period and handle the event; generating a first help order associated with the help request; transmitting the first help order to a first terminal associated with the first service provider.

In some embodiments, the user terminal may include a driver terminal and/or a passenger terminal.

In some embodiments, the first help order may include at least one of the location where the event happens, a type of the event, and contact information of the user.

In some embodiments, the determining a first service provider from a candidate service provider set based on the help request may further include: obtaining a first feature of the help request; obtaining a second feature of each of at least one candidate service provider of the candidate service provider set; determining a first matching degree between the each of the at least one candidate service provider of the candidate service provider set and the help request based on the first feature and the second feature; and determining the first service provider from the candidate service provider set based on the first matching degree.

In some embodiments, the first feature of the help request may include at least one of the location where the event happens, a type of the event, and a time when the event happens.

In some embodiments, the second feature may include at least one of a skill type and a geographic location of the at least one candidate service provider.

In some embodiments, the determining a first matching degree between the each of the at least one candidate service provider of the candidate service provider set and the help request based on the first feature and the second feature may include: determining a first distance between the geographic location of the each of the at least one candidate service provider of the candidate service provider set and the location where the event happens; determining a matching degree between the skill type of the each of the at least one candidate service provider of the candidate service provider set and the type of the event; and determining the first matching degree based on the first distance and the matching degree between the skill type and the type of the event.

In some embodiments, the determining the first service provider from the candidate service provider set based on the first matching degree may include: in response to the first matching degree of the each of the at least one candidate service provider smaller than a first threshold, determining the candidate service provider as the first service provider.

In some embodiments, the method may further include: obtaining feedback information transmitted by the first terminal, the feedback information including an assessment of the first service provider on the event; determining a second service provider from the candidate service provider set based on the help request and the feedback information; generating a second help order associated with the help request, the second help order including at least one of the location where the event happens, the type of the event, and contact information of the user; transmitting the second help order to a second terminal associated with the second service provider.

In some embodiments, the determining a second service provider from the candidate service provider set based on the help request and the feedback information may include: obtaining a third feature of the help request and a fourth feature of the feedback information, the third feature including the location where the event happens, the fourth feature including the assessment of the first service provider on the event; obtaining a fifth feature of each of the at least one candidate service provider of the candidate service provider set, the fifth feature including a skill type and a geographical location of the at least one candidate service provider; determining the second service provider from the candidate service provider set based on the third feature, the fourth feature, and the fifth feature.

In some embodiments, the determining the second service provider from the candidate service provider set based on the third feature, the fourth feature, and the fifth feature may further include: determining a second distance between the geographical location of the each of the at least one candidate service provider of the candidate service provider set and the location where the event happens; determining a matching degree between the skill type of the each of the at least one service provider of the candidate service provider set and the assessment of the first service provider on the event; determining a second matching degree based on the second distance and the matching degree between the skill type and the assessment of the first service provider on the event; in response to the second matching degree of the each of the at least one candidate service provider of the candidate service provider set smaller than a second threshold, determining the candidate service provider as the second service provider.

In some embodiments, the method may further include: obtaining completing information of the help order transmitted by the user terminal. The completing information of the help order may include at least one of a time duration for handling the event and assessment on the event.

In a second aspect, the present disclosure may disclose an information processing system. The system may include: a first obtainment module configured to obtain a help request transmitted by a user terminal, the help request being in response to an event associated with a user; a first determination module configured to determine a first service provider from a candidate service provider set based on the help request, the first service provider having an ability to arrive at a location where the event happens within a preset time period and handle the event; a first generation module configured to generate a first help order associated with the help request; and a first transmission module configured to transmit the first help order to a first terminal associated with the first service order.

In some embodiments, the user terminal may include a driver terminal and/or a passenger terminal.

In some embodiments, the first help order may include at least one of the location where the event happens, a type of the event, and contact information of the user.

In some embodiments, the first determination module may include: a first obtainment unit configured to obtain a first feature of the help request; a second obtainment unit configured to obtain a second feature of each of at least one candidate service provider of the candidate service provider set; a first determination unit configured to determine a first matching degree between the at least one candidate service provider of the candidate service provider set and the help request based on the first feature and the second feature.

In some embodiments, the first feature of the help request may include at least one of the location where the event happens, a type of the event, and a time when the event happens.

In some embodiments, the second feature may include at least one of a skill type and a geographic location of the at least one candidate service provider.

In some embodiments, the first determination unit may include: a first determination subunit configured to determine a first distance between the geographic location of the each of the at least one candidate service provider of the candidate service provider set and the location where the event happens, determine a matching degree between the skill type of the each of the at least one candidate service provider of the candidate service provider set and the type of the event, and determine the first matching degree based on the first distance and the matching degree between the skill type and the type of the event.

In some embodiments, the first determination unit may further include: a second determination subunit configured to in response to the first matching degree of the each of the at least one candidate service provider smaller than a first threshold, determine the candidate service provider as the first service provider.

In some embodiments, the system may further include a second obtainment module configured to obtain feedback information transmitted by the first terminal, the feedback information including an assessment of the first service provider on the event; a second determination module configured to determine a second service provider from the candidate service provider set based on the help request and the feedback information; a second generation module configured to generate a second help order associated with the help request, the second help order including at least one of the location of where the event happens, a type of the event, and contact information of the user; a second transmission module configured to transmit the second help order to a second terminal associated with the second service provider.

In some embodiments, the second determination module may include: a first obtainment unit configured to obtain a third feature of the help request and a fourth feature of the feedback information, the third feature including the location where the event happens, the fourth feature including the assessment of the first service provider on the event; a second obtainment unit configured to obtain a fifth feature of each of at least one candidate service provider of the candidate service provider set, the fifth feature including a skill type and a geographical location of the at least one candidate service provider; and a first determination unit configured to determine the second service provider from the candidate service provider set based on the third feature, the fourth feature, and the fifth feature.

In some embodiments, the first determination unit may include: a first determination subunit configured to determine a second distance between the geographical location of the each of the at least one candidate service provider of the candidate service provider set and the location where the event happens, determine a matching degree between the skill type of the each of the at least one service provider of the candidate service provider set and the assessment of the first service provider on the event, and determine a second matching degree based on the second distance and the matching degree between the skill type and the assessment of the first service provider on the event; a second determination subunit configured to in response to the second matching degree of the each of the at least one candidate service provider of the candidate service provider set smaller than a second threshold, determine the candidate service provider as the second service provider.

In some embodiments, the system may further include a third obtainment module configured to obtain completing information of the help order transmitted by the user terminal, wherein the completing information of the help order includes at least one of a time duration for handling the event and an assessment on the event.

In a third aspect, the present disclosure may disclose a computer-readable storage medium storing computing instructions. When the computing instructions are executed, the information processing method may be performed.

In a fourth aspect, the present disclosure may disclose an information processing device. The information processing device may include a processor configured to perform the information processing method.

In a fifth aspect, the present disclosure may disclose an information processing method. The method may include obtaining event information; generating and transmitting a help request, the help request at least including a type of the event and a location where the event happens; obtaining relating information of a service provider, the relating information of the service provider at least including contact information and a location of the service provider.

In some embodiments, the method may include transmitting completing information of a help order. The completing information of the help order may include at least one of a time duration for handling the event and an assessment on the event.

In a sixth aspect, the present disclosure may disclose an information processing system. The system may include: a second obtainment module configured to obtain event information; a third generation module configured to generate and transmit a help request, the help request at least including a type of the event and a location where the location happens; a third obtainment module configured to obtain relating information of a service provider, the relating information of the service provider at least including contact information and a location of the service provider.

In some embodiments, the system may further include a third transmission module configured to transmit completing information of a help order, the completing information of the help request including at least one of a time duration for handling the event and an assessment on the event.

In a seventh aspect, the present disclosure may disclose a computer-readable storage medium including computing instructions. When the computing instructions are executed, the information processing method may be performed.

In an eighth aspect, the present disclosure may disclose an information processing device. The information processing device may include a processor configured to perform the information processing method.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The drawings described herein are used to provide a further understanding of the present disclosure, all of which form a part of the present disclosure. The exemplary embodiment(s) and the descriptions of the present disclosure are for the purpose of illustration only and are not intended to limit the scope of the present disclosure. The same reference numerals in each figure indicate the same components.

FIG. 1 is a schematic diagram illustrating an on-demand service system according to some embodiments of the present disclosure;

FIG. 2 is a block diagram illustrating an exemplary computing device for implementing a dedicated system of a technical solution in the present disclosure;

FIG. 3 is a block diagram illustrating an exemplary mobile device for implementing a dedicated system of a technical solution in the present disclosure;

FIG. 4 is a flowchart illustrating a process of an information processing method 400 according to some embodiments of the present disclosure;

FIG. 5 is a flowchart illustrating a process of a method for implementing operation 402 of an information processing method according to some embodiments of the present disclosure;

FIG. 6 is a flowchart illustrating a process of another information processing method 600 according to some embodiments of the present disclosure;

FIG. 7 is a flowchart illustrating a process of a method for implementing operation 606 of an information processing method according to some embodiments of the present disclosure;

FIG. 8 is a functional block diagram illustrating an information processing device 800 according to some embodiments of the present disclosure;

FIG. 9 is a functional block diagram illustrating a first determination module 820 according to some embodiments of the present disclosure;

FIG. 10 is a functional block diagram illustrating a first determination unit 930 according to some embodiments of the present disclosure;

FIG. 11 is a functional block diagram illustrating another information processing device 1100 according to some embodiments of the present disclosure;

FIG. 12 is a functional block diagram illustrating a second determination module 860 according to some embodiments of the present disclosure;

FIG. 13 is a functional block diagram illustrating a second determination module 1230 according to some embodiments of the present disclosure;

FIG. 14 is a flowchart illustrating a process of another information processing method 1400 according to some embodiments of the present disclosure; and

FIG. 15 is a functional block diagram illustrating another information processing device 1500 according to some embodiments of the present disclosure.

### DETAILED DESCRIPTION

In order to illustrate the technical solutions related to the embodiments of the present disclosure, a brief introduction of the drawings referred to in the description of the embodiments is provided below. It will be apparent that the drawings in the following description are merely some examples or embodiments of the present disclosure. For those in the art, the present disclosure may be applied to other similar scenarios in accordance with the drawings without the premise of creative labor. Unless obviously obtained from the context or the context illustrates otherwise, the same numeral in the drawings refers to the same structure or operation.

As used in the disclosure and the appended claims, the singular forms “a,” “an,” and “the” include plural referents unless the content clearly dictates otherwise. In general, the terms “comprise” and “include” only prompt steps and elements that include explicitly identified, these steps and elements do not constitute an exclusive listing. Methods or devices may also contain other steps or elements.

Though the present disclosure makes various references to certain modules or units in the system of the embodiments of the present disclosure, any number of different modules or units may be used and run on a client and/or server. The modules are merely illustrative, and different modules may be used in different aspects of the systems and methods.

The flowchart is used in the present disclosure to illustrate the operations performed by the system according to the embodiments of the present disclosure. It should be understood that the front or the following operations are not necessarily performed in order. Instead, various operations may be processed in reverse or simultaneously. At the same time, other operations may be added to these procedures, or one or more operations removed from these procedures.

Embodiments of the present disclosure may be applied to different transport systems, and the different transport systems may include but not be limited to land, ocean, aerospace, or the like, or any combination thereof. For example, the transportation systems may include a taxi, a chauffeur car, a hitch, a bus, a designated driving service, a train, a bullet train, a high-speed rail, a vessel, an aircraft, a hot-air balloon, a spaceship, an unmanned transport, a management and/or distribution transportation system for transmitting and/or receiving an express, etc. Different embodiments of the present disclosure may be used in application scenarios such as a webpage, a plug-in of a browser, a client terminal, a custom system, an internal analysis system, an artificial intelligence robot, or the like, or any combination thereof. It should be understood that the application scenarios of the systems and methods of the present disclosure are only some examples or embodiments of the present disclosure, and those having ordinary skills in the art may apply the present disclosure to other similar scenarios in accordance with the drawings without any creative effort.

The term “passenger,” “passenger terminal,” “user terminal,” “user,” “requester,” “service requester,” “customer,” “consumer,” and “usage requester” in the present disclosure are used interchangeably to refer to a party that may request or order a service, which may be an individual or a tool. Also, the term “driver,” “driver terminal,” “provider,” “supplier,” “service provider,” and “server party” in the present disclosure are used interchangeably to refer to an individual, an entity, or a tool that may provide a service or facilitate the providing of the service. In addition, the term “user” in the present disclosure may refer to an individual, an entity, or a tool that may request a service, order a service, provide a service, or facilitate the providing of the service.

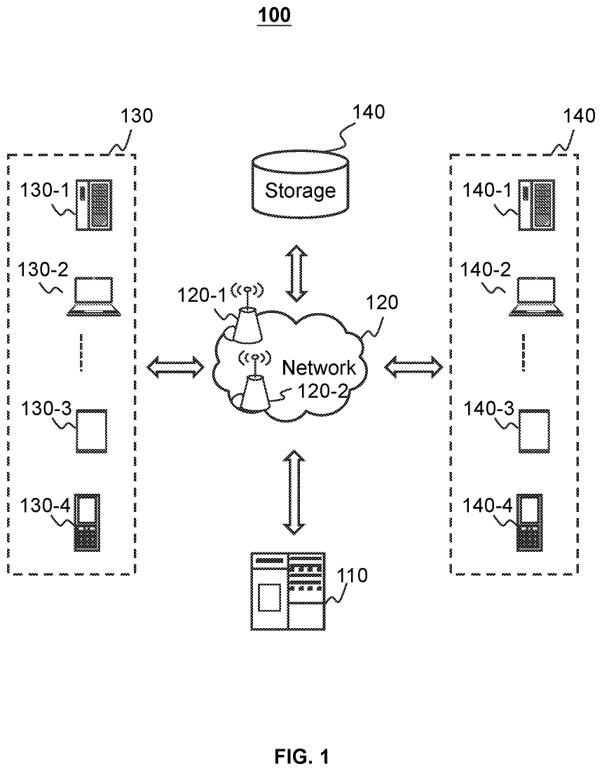

FIG. 1 is a schematic diagram illustrating an on-demand service system according to some embodiments of the present disclosure.

An online to offline service system 100 may include a server 110, a service request terminal 130, a storage 150, a service providing terminal 140, and a network 120.

The server 110 may be local or remote. The server 110 may be used to perform instructions (program codes). For the convenience of the descriptions, the server 110 may be referred to as an information processing device. The information processing device may be disposed within the service request terminal 130 and the service providing terminal 140. The information processing device may also be remote.

In some embodiments, the server 110 may be a system that analyzes collected information to generate an analysis result. For example, the server 110 may obtain relating information of the service request terminal 130 and the service providing terminal 140 to determine a matching degree between the service request terminal 130 and the service providing terminal 140. In some embodiments, the server 110 may be a terminal device, a single server, or a server group. The server group may be centralized, for example, a data center. The server group may also be distributed, for example, a distributed system.

The service request terminal 130 may refer to an individual, a tool, or other entities that transmit a help order. The service request terminal 130 may also be referred to as a user terminal. In some embodiments, the service request terminal 130 may also be referred to as a service requester or a terminal associated with the service requester. In some embodiments, the service request terminal 130 may be a user of a passenger terminal and/or a user of a driver terminal that transmits a help request. For example, when a passenger conflicts with a driver, the passenger and/or the driver may choose to transmit a help request to the server 110. In some embodiments, the service request terminal 130 may include but not be limited to, a desktop computer 130-1, a laptop computer 130-2, a built-in device in a vehicle 130-3, a mobile device 130-4, or the like, or any combination thereof.

The service providing terminal 140 may be an individual, a tool, or other entities that handle the help order. The service providing terminal 140 may also be referred to as a service provider or a terminal associated with a service provider. In some embodiments, the service providing terminal 140 may be a driver that transmits a help request. For example, when the driver's vehicle malfunctions, the driver may choose to transmit a help request to the server 110.

In some embodiments, the service request terminal 130 may also be a passenger that receives the help request transmitted by the passenger or the driver. In some embodiments, the service providing terminal 130 may also be a driver that receives the help request transmitted by the passenger or the driver. These passengers or drivers may be a part of passengers or drivers selected from a system platform, be served as the service providers, and have targeted professional trainings according to their work experience. The professional trainings may include but not be limited to a vehicle rescue, a vehicle maintenance, an accident survey, a personal injury accident treatment, a conflict mediation, a first aid, etc. When an emergency occurs, the system platform may dispatch a rescue task to an appropriate service provider (for example, a closest passenger or driver that has the professional training) based on an event feature, a type of the event, a skill of the service provider, a location of the service provider, completing information of historical events handled by the service provider, or the like, so as to rescue and handle the emergency rapidly. It should be understood that, in some embodiments, the service provider may be a driver that is driving a vehicle or a passenger that is using the vehicle.

In some embodiments, the service providing terminal 140 may include but not be limited to, a desktop computer 140-1, a tablet computer 140-2, a built-in device in a vehicle 140-3, a mobile device 140-4, or the like, or any combination thereof. The server 110 may directly access information stored in the storage 150, or directly access information of the terminal 130/140 through the network 120.

In some embodiments, the service request terminal 130 and/or the service providing terminal 140 may be a device having a positioning technique for locating the service request terminal 130 and/or the service providing terminal 140. In some embodiments, the service request terminal 130 and/or the service providing terminal 140 may transmit the acquired data/information through the network 140 to the processing device 110 for subsequent operations. The service request terminal 130 and/or the service providing terminal 140 may also store the acquired data/information to its own storage device or transmit it to the storage 150 for storage through the network 12. The service request terminal 130 and/or the service providing terminal 140 may also receive and/or display notifications associated with the help request generated by the server 110.

The storage 150 may refer to a device having a storage function. The storage 150 may be primarily used to store data collected from the service request terminal 130 and/or the service providing terminal 140 and various data generated during an operation of the online to offline service system 100. For example, the storage 150 may store experiences of the professional trainings of the driver and/or the passenger. In some embodiments, the storage 150 may include a mass storage, a removable storage, a volatile read-and-write memory, a read-only memory (ROM), or the like, or any combination thereof. Exemplary mass storage may include a magnetic disk, an optical disk, solid-state drives, etc. Exemplary removable storages may include a flash drive, a floppy disk, an optical disk, a memory card, a zip disk, a magnetic tape, etc. Exemplary volatile read-and-write memories may include a random-access memory (RAM). Exemplary RAMs may include a dynamic RAM (DRAM), a double date rate synchronous dynamic RAM (DDR SDRAM), a static RAM (SRAM), a thyristor RAM (T-RAM), a zero-capacitor RAM (Z-RAM), etc. Exemplary ROMs may include a mask ROM (MROM), a programmable ROM (PROM), an erasable programmable ROM (EPROM), an electrically-erasable programmable ROM (EEPROM), a compact disk ROM (CD-ROM), a digital versatile disk ROM, etc. In some embodiments, the storage 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the storage 150 may be local or remote. The storage 150 may be connected to or communicated with other components of the online to offline system 100 through a wired or a wireless manner. In some embodiments, the storage 150 may be a part of the processing device 110.

The network 120 may provide channels for exchange of information and/or data. The network 120 may be a single network or a combination of various networks. The network 120 may include a cable network, a wireline network, an optical fiber network, a telecommunications network, an intranet, an Internet, a local area network (LAN), a wide area network (WAN), a wireless local area network (WLAN), a metropolitan area network (MAN), a public telephone switched network (PSTN), a Bluetooth network, a ZigBee network, a near field communication (NFC) network, a global system for mobile communications (GSM) network, a code division multiple access (CDMA) network, a time division multiple access (TDMA) network, a general packet radio service (GPRS) network, an enhanced data rate GSM evolution (EDGE) network, a wideband code division multiple access (WCDMA) network, a high speed downlink packet access (HSDPA) network, a long-term evolution (LTE) network, a user datagram protocol (UDP) network, a transmission control protocol/Internet protocol (TCP/IP) network, a short message service (SMS) network, a wireless application protocol (WAP) network, an ultra-wide bandwidth (UWB) network, a mobile communication (1G, 2G, 3G, 4G, 5G) network, a Wi-Fi, a Li-Fi, a narrow band internet of things (NB-IoT), or the like, or any combination thereof. In some embodiments, the network 120 may include one or more network access points. For example, the network 120 may include wired or wireless network access points such as base stations and/or internet exchange points 120-1, 120-2, through which one or more components of the on-demand service system 100 may be connected to the network 120 to exchange the data and/or the information.

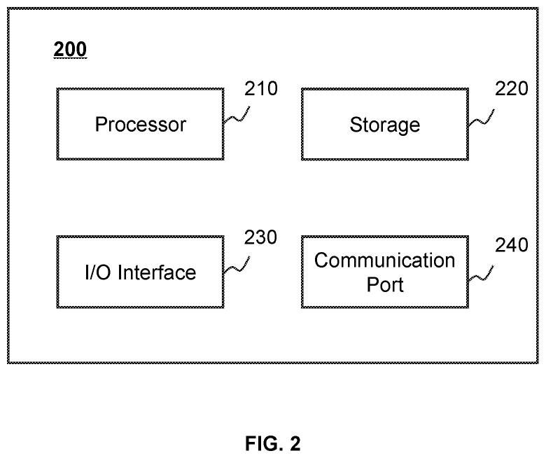

FIG. 2 is a block diagram illustrating an exemplary computing device 200 for implementing a dedicated system of a technical solution in the present disclosure. The computing device 200 may be used to implement any component of the system 100 described in the present disclosure. For example, the server 110 may be implemented on the computing device 200 via its hardware, software program, firmware, or a combination thereof. Although only one such computer is shown for convenience, the computing functions related to the online to offline system 100 as described in the present disclosure may be implemented in a distributed manner on a number of similar platforms to distribute the processing load.

As shown in FIG. 2, the computing device 200 may include a processor 210, a storage 220, an input/output (I/O) interface 230, and a communication port 240.

The processor 210 may execute computing instructions (e.g., program codes) and perform functions of the online to offline system 100 of the present disclosure. For example, the processor 210 may obtain a help request transmitted by the service request terminal 130 and/or the service providing terminal 140 and dispatch the help request to a corresponding service personnel to complete the help request. The computing instructions may include, for example, programs, objects, components, data structures, procedures, modules, and functions (particular functions described in the present disclosure). For example, the processor 210 may process image data or text data obtained from other components of the online to offline service system 100. In some embodiments, the processor 210 may include one or more hardware processors, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof. Merely for illustration, only one processor is described in the computing device 200. However, it should be noted that the computing device 200 in the present disclosure may also include multiple processors.

The storage 220 may store data/information obtained from other components of the online to offline service system 100. In some embodiments, the storage 220 may include a mass storage, a removable storage, a volatile read-and-write memory, a read-only memory (ROM), or the like, or any combination thereof. For example, the mass storage may include a magnetic disk, an optical disk, a solid-state drive, etc. The removable storage may include a flash drive, a floppy disk, an optical disk, a memory card, a zip disk, a magnetic tape, etc. The volatile read-and-write memory may include a random access memory (RAM). The RAM may include a dynamic RAM (DRAM), a double date rate synchronous dynamic RAM (DDR SDRAM), a static RAM (SRAM), a thyristor RAM (T-RAM), a zero-capacitor RAM (Z-RAM), etc. The ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc.

The I/O interface 230 may input and/or output signals, data, information, etc. In some embodiments, the I/O interface 230 may enable a user interaction with the online to offline service system 100. In some embodiments, the I/O interface 230 may include an input device and an output device. Exemplary input devices may include a keyboard, a mouse, a touch screen, a microphone, or the like, or a combination thereof. Exemplary output devices may include a display device, a loudspeaker, a printer, a projector, or the like, or a combination thereof. Exemplary display devices may include a liquid crystal display (LCD), a light-emitting diode (LED)-based display, a flat panel display, a curved screen, a television device, a cathode ray tube (CRT), a touch screen, or the like, or a combination thereof.

The communication port 240 may be connected to a network to facilitate data communication. The connection may be a wired connection, a wireless connection, or any combination thereof. The wired connection may include, for example, an electrical cable, an optical cable, a telephone wire, or the like, or any combination thereof. The wireless connection may include, for example, a Bluetooth™ link, a Wi-Fi, a WiMax link, a WLAN link, a ZigBee™ link, a mobile network link (e.g., 3G, 4G, 5G, etc.), or the like, or a combination thereof. In some embodiments, the communication port 240 may be and/or include a standardized communication port, such as RS232, RS485, etc.

Merely for illustration, only one processor is described in FIG. 2. It should be noted that the computing device 200 may include multiple processors. Thus, operations and/or methods performed by one processor as described in the present disclosure may also be jointly or separately performed by the multiple processors. For example, if in the present disclosure the processor of the computing device 200 executes both operation 1 and operation 2, it should be understood that operation 1 and operation 2 may also be performed by two different processors jointly or separately in the computing device 200 (e.g., the first processor executes operation 1 and the second processor executes operation 2, or the first and second processors jointly execute operations 1 and 2).

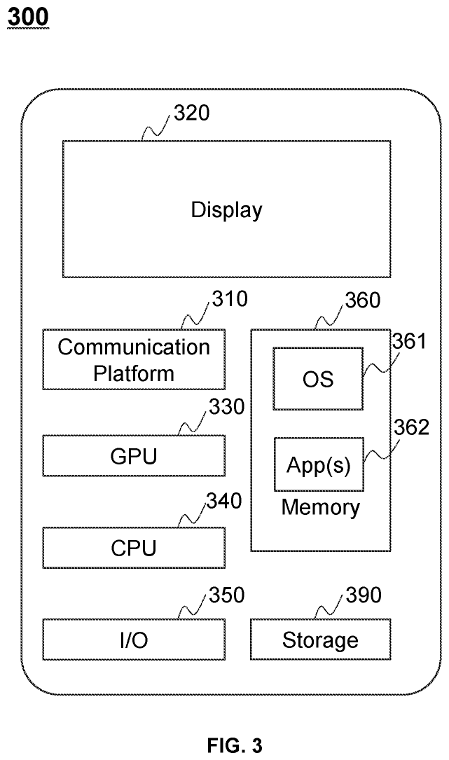

FIG. 3 is a block diagram illustrating an exemplary mobile device 300 for implementing a dedicated system of a technical solution in the present disclosure. The service request terminal 130 and/or the service providing terminal 140 may be implemented on the mobile device 300.

As shown in FIG. 3, the mobile device 300 may include a communication platform 310, a display 320, a graphic processing unit (GPU) 330, a central processing unit (CPU) 340, an I/O 350, a memory 360, and a storage 370. In some embodiments, any other suitable component, including but not being limited to a system bus or a controller (not shown), may also be included in the mobile device 300.

In some embodiments, a mobile operating system (OS) 361 (e.g., iOS™, Android™, Windows Phone™, etc.) and one or more applications 362 may be loaded into the memory 360 from the storage 370 in order to be executed by the CPU 340. The applications 362 may include a browser or any other suitable mobile applications for transmitting data/information associated with a help request, and receiving and displaying an application of the processing of the online to offline service system 100 or other information. An interaction between a user and an information stream may be achieved via the I/O 350 and provided to the server 130 and/or other components of the system 100 via the network 120. For example, the application 362 may be an online taxi-hailing platform, the user (e.g., a driver or a passenger) may transmit the help request through the application 362, and transmit request information to a back-end server, for example, the server 110. An interaction between the user and an information stream may be implemented through the I/O 350, and be provided to the server 110 and/or other components of the online to offline system 100 via the network 120.

To implement various modules, units, and their functionalities described in the present disclosure, the computing device or the mobile device may be used as a hardware platform of one or more components in the present disclosure. A hardware component, an operating system, and a programming language of the computing device(s) or the mobile device(s) are conventional in nature, and those skilled in the art may adapt these technologies to the on-demand service system described in the present disclosure, after understanding these technologies. A computer with user interface elements may be used to implement a personal computer (PC) or any other types of workstations or terminal devices. A computer may also be acted as a server if appropriately programmed.

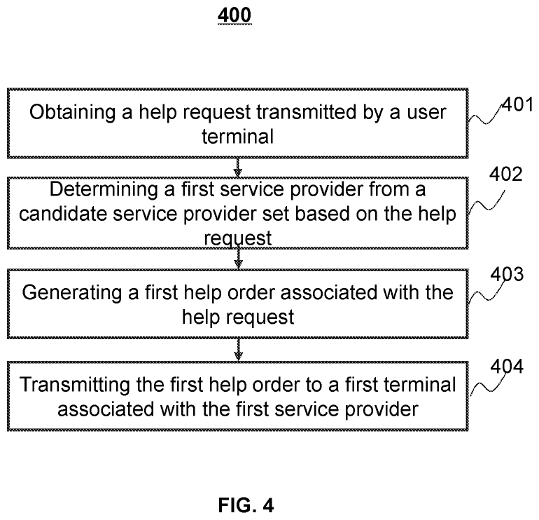

FIG. 4 is a flowchart illustrating a process of an information processing method 400 according to some embodiments of the present disclosure. In some embodiments, the information processing method 400 may be implemented by the server 110 (e.g., an information processing device 800), the computing device 200, etc., that has processing and computing capacity. For example, one or more operations in the method 400 may be stored in the storage 150 and/or the storage 220 as a form of instructions and invoked and/or executed by the server 110.

In 401, a help request transmitted by a user terminal may be obtained. Operation 401 may be executed by a first obtainment module 810.

In some embodiments, the user terminal may include a driver terminal and/or a passenger terminal. The help request may be in response to an event associated with a user. For example, when an emergency occurs while driving a vehicle, a corresponding user (e.g., a driver and/a passenger) may transmit the help request to the server 110 through a terminal device (e.g., a mobile phone of the driver terminal 140 and/or the passenger terminal 130). A type of the emergency may include, but not be limited to a vehicle malfunction (e.g., a rear-end collision, a vehicle breakdown), a conflict between the driver and the passenger (simply referred to as a driver-passenger conflict), a personal injury, a traffic accident, etc. For example, when the driver's vehicle malfunctions and needs to be rescued, the driver or the passenger may transmit the help request to the server 110 through the terminal device.

In some embodiments, the help request may include, but not be limited to, a location where the event happens, a type of the event, user contract information, a time for transmitting the help request. The location where the event happens may refer to a location where the emergency happens. The type of the event may refer to a type of the emergency. The user contract information may refer to contact information of the user (e.g., the driver/the passenger) who transmits the help request, e.g., a telephone number. The time for transmitting the help request may refer to a time when the help request is transmitted. In some embodiments, a form of the help request may include a speech form, a text form, an image form, a video form, or the like, or any combination thereof. For example, the user may transmit a voice for describing the help request to the server 110 through a user terminal. As another example, the user may transmit the help request to the server 110 in the form of a text. For example, the user may input the help request through the terminal device, for example, that there is a rear-end collision and a help is urgently needed. As another example, the user may take pictures of a site of the event using the terminal device, and transmit the image to the server 110 for help. As another example, the user may record a video of the site of the event using the terminal device, and transmit the video to the server 110 for help. In some embodiments, the online to offline service system 100 may provide the user with various types of events. The user may select a type of an event that matches the event associated with the user from the various types of events through the user terminal. In some embodiments, the online to offline service system 100 may obtain the location where the event happens through a positioning device of the user terminal.

In 402, a first service provider may be determined from a candidate service provider set based on the help request. Operation 401 may be executed by a first determination module 820.

In some embodiments, the first service provider may have the ability or a skill to arrive at the location where the event happens within a preset time period and handle the event. For example, when a vehicle malfunctions, the user may transmit the help request. The first service provider may arrive at the location of the malfunctioned vehicle within a given time period such as 10 minutes, and repair the vehicle. In some embodiments, the candidate service provider set may include at least one candidate service provider. Each candidate service provider may have a skill for processing at least one type of emergencies. For example, the candidate service provider set may include a candidate service provider 1, a candidate service provider 2, a candidate service provider 3, . . . , a candidate service provider N. The candidate service provider 1 may have a skill of a vehicle repair, that is, a skill needed for the vehicle malfunction in the types of the events. The candidate service provider 2 may have a skill of a conflict mediation, that is, a skill needed for the driver-passenger conflict in the types of the events. The candidate service provider 3 may have a skill of a first aid, that is, a skill needed for the personal injury in the types of the events.

In some embodiments, some candidate service providers may have two or more of the skills. For example, if a candidate service provider's occupation is a doctor, and has a certain ability to repair the vehicle, the candidate service provider may have the skills needed for the personal injury and the vehicle malfunction in the types of the events. In some embodiments, some candidate services may not have the skill to handle the emergency, and these candidate service providers may assist those candidate service providers having the skills to handle the emergencies in handling the emergencies, or handle some affairs that do not require a professional skill.

In some embodiments, a service provider in the candidate service provider set may be a user of the service providing terminal 140. For example, the service provider in the candidate service provider set may be a driver and/or a passenger other than a driver or a passenger who is involved in an emergency when the emergency occurs. In some embodiments, the candidate service provider set may be determined based on a distance. For example, a set distance range may be determined based on the location where the event happens, such as 1 km, and service providers within the distance may form the candidate service provider set.

In some embodiments, the server 110 (e.g., the first determination module 820 of the information processing device 800) may select the first service provider that matches the user's help request from the candidate service provider set based on the user's help request.

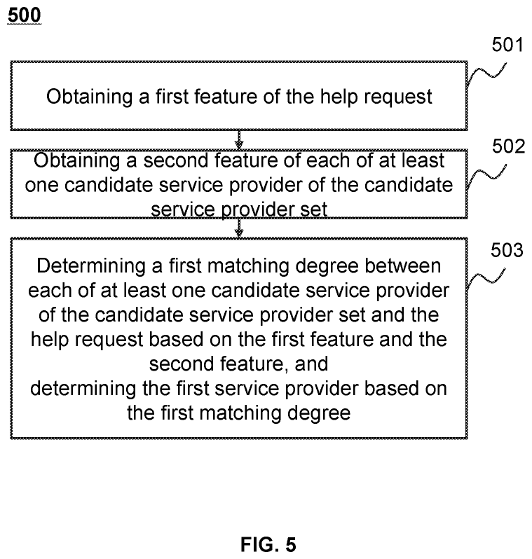

As to operation 402, the first service provider may be determined from the candidate service provider set based on the help request. Some embodiments of the present disclosure may provide an exemplary implementation method 500, which may be referred to relevant descriptions of FIG. 5.

In 403, a first help order associated with the help request may be generated. Operation 403 may be executed by a first generation module 830.

In some embodiments, the server 110 (for example, the first generation module 830 of the information processing device 800) may generate the first help order based on a specific content included in the user's help request. The first help order may include at least of the location where the event happens, the type of the event, the contact information of the user, or the like. The location where the event happens and the type of the event may be the same as or similar to those included in the help request. The contact information of the user may be contact information of a user who transmits the help request, such as contact information of the driver or the passenger, including but not being limited to a telephone number, a mobile phone number, social account information (such as a WeChat number, a QQ number, LinkedIn, etc.), or the like, or any combination thereof. For example, the first help order may include that a location where the event happens is Zhongguancun subway station in Haidian District, Beijing, the type of the event is a vehicle collision, and the contact information of the user is mobile phone number XXXX.

In 404, the first help order may be transmitted to a first terminal associated with the first service provider. Operation 404 may be executed by a first transmission module 840.

In some embodiments, the server 110 (e.g., the first transmission module 840 of the information processing device 800) may transmit the first help order to the first terminal associated with the first service provider via network 120. The first terminal may refer to a terminal used by the first service provider, for example, a mobile phone of the service providing terminal 140. The first help order may be transmitted to the first terminal in the form of a text, an image, an audio, a video, or the like, or any combination thereof. The first terminal may display the first help order to the first service provider after receiving the first help order. For example, the first help order may be displayed to the first service provider via the display 320.

In some embodiments, the information processing method 400 may further include obtaining completing information of the help order transmitted by the user terminal. When the emergency is handled, the user terminal may generate the completing information of the help order based on information associated with the handling of the emergency, and transmit the completing information to the server 110 via the network 120. The completing information of the help order may at least include a time duration for handling the event and an assessment on the event. For example, when the emergency is completed, the user of the user terminal may input the information associated with the handling of the emergency into the user terminal according to a specific process for handling the event. After receiving such information, the user terminal may generate the completing information of the help order and transmit it to the server 110.

It should be noted that the above descriptions are provided only for illustrative purposes and not intended to limit the scope of the present disclosure. For those skilled in the art, various changes and modifications may be made in accordance with the teachings of the present disclosure. Any modification, equivalent replacement, improvement, etc., according to the spirit and principles of the present disclosure shall be included within the scope of the present disclosure.

FIG. 5 is a flowchart illustrating a process of a method 500 for implementing operation 402 of an information processing method according to some embodiments of the present disclosure. In some embodiments, the method 500 may be performed by the first determination module 820. As shown in FIG. 5, operation 402 may include the following operations.

In 501, a first feature of the help request may be obtained. Operation 501 may be performed by a first obtainment unit 910.

In some embodiments, the server 110 (e.g., the first obtainment unit 910 of the first determination module 820 of the information processing device 800) may obtain the first feature of the help request. The first feature may include but be not limited to the location where the event happens, the type of the event, etc. The location where the event happens may be represented by a coordinate (X0, Y0), such as a latitude coordinate, a longitude coordinate, a map coordinate, or the like. The type of the event may be represented by a vector. For example, assuming that the server 110 may set three types of events for the user to select, such as a vehicle malfunction, a driver-passenger conflict, and a personal injury, when the user selects the vehicle malfunction as the type of the event, a vector representing the type of the event may be [1, 0, 0]; when the user selects the type of the event including the vehicle malfunction and the driver-passenger conflict, the vector representing the type of the event may be [1, 1, 0]. The digit 1 in the vector may represent that the user selects a corresponding type of an event, and the digit 0 may represent that the user does not select the corresponding type of an event. In some embodiments, when the digit is greater than 0, the larger the digit (e.g., 2, 3, 4) is, the higher severity level may be and the more serious the event may be.

In 502, a second feature of each of at least one candidate service provider of the candidate service provider set may be obtained. Operation 502 may be performed by a second obtainment unit 920.

In some embodiments, the server 110 (e.g., the second obtainment unit 920 of the first determination module 820 of the information processing device 800) may obtain the second feature of each of at least one candidate service provider of the candidate service provider set. The second feature may include but be not limited to a skill type of the candidate service provider, a geographic location of the candidate service provider, or the like. The geographic location of the candidate service provider may be represented by a coordinate (x1, y1), such as a latitude coordinate, a longitude coordinate, a map coordinate, or the like. The skill type of the candidate service provider may be represented by a vector. For example, the server 110 (e.g., the second obtainment unit 920 of the first determination module 820 of the information processing device 800) may set required skills corresponding to the types of the events. Assuming that the types of the events may include three types including the vehicle malfunction, the driver-passenger conflict, and the personal injury. The corresponding required skills may be set according to the types of the events, including the vehicle repair, the conflict mediation, and the first aid. Then, vector representation of the skills of the candidate service providers may be determined based on whether the candidate service provider masters the skill. For example, assuming that the candidate service provider has the skill of the vehicle repair, that is, the skill required for the vehicle malfunction in the type of the event. The vector representation of the skill type of the candidate service provider may be [1, 0, 0]. For example, if a candidate service provider has skills of the vehicle repair and the conflict mediation, the vector representation of the skill of the candidate service provider may be [1, 1, 0]. The digit 1 may represent that the candidate service provider has the corresponding skill type, and the digit 0 may represent that the candidate service provider does not have the corresponding skill. In some embodiments, when the digit is greater than 0, the larger the digit (e.g., 2, 3, 4) is, the higher skill level of the candidate service provider may be, and the higher skill of the candidate service provider may be.

In 503, a first matching degree between each of at least one candidate service provider of the candidate service provider set and the help request may be determined based on the first feature and the second feature, and the first service provider may be determined based on the first matching degree. Operation 503 may be executed by a first determination unit 930.

In some embodiments, the server 110 (e.g., the first determination unit 930 of the first determination module 820 of the information processing device 800) may determine the first matching degree of each of at least one candidate service provider of the candidate service provider set by matching the location where the event happens with a geographical location of the candidate service provider and matching the type of the event with the skill type of the candidate service provider. Further, the server 110 (e.g., the first determination unit 930 of the first determination module 820 of the information processing device 800) may determine the first service provider based on the first matching degree.

In some embodiments, the server 110 (e.g., a first determination subunit 1010 of the first determination unit 930 of the first determination module 820 of the information processing device 800) may first determine a first distance between a geographical location of each of at least one candidate service provider of the candidate service provider set and the location where the event happens. The server 110 (e.g., the first determination subunit 1010 of the first determination unit 930 of the first determination module 820 of the information processing device 800) may also determine a matching degree between the skill type of each of at least one candidate service provider of the candidate service provider set and the type of the event, and determine the first matching degree based on the first distance and the matching degree between the skill type and the type of the event. When the first matching degree of one of the at least one candidate service provider of the candidate service provider set is smaller than a first threshold, the server 110 (e.g., a second determination subunit 1020 of the first determination unit 930 of the first determination module 820 of the information processing device 800) may determine the service provider as the first service provider.

For example, assuming that the candidate service provider set includes 5 candidate service providers, and information of the candidate service provider is represented as (ID, gender, age, telephone, skill 1 (vehicle repair), skill 2 (conflict mediation), skill 3 (first aid), location coordinate), such as:

Candidate service provider 1 (001, male, 30, 1, [1, 0, 0], X1, Y1);

Candidate service provider 2 (002, male, 28, 2, [0, 1, 0], X2, Y2);

Candidate service provider 3 (003, male, 35, 3, [0, 0, 1], X3, Y4);

Candidate service provider 4 (004, male, 40, 4, [1, 1, 0], X4, Y4);

Candidate service provider 5 (005, male, 26, 5, [1, 0, 0], X5, Y5).

where, the digit 1 in a vector of the skill type of the candidate service provider may represent that the candidate service provider has the skill, and the digit 0 may represent that the candidate service provider does not have the skill. When the digit is greater than 0, the larger the digit (e.g., 2, 3, 4) is, the higher the skill level of the candidate service provider may be. For example, when the skill level of the vehicle repair of the candidate service provider 1 is 3, information of the candidate service provider 1 may be represented as (001, male, 30, 1, [3, 0, 0], X1, Y1).

In addition, information included in the help request may be represented as (user ID, gender, age, telephone, event type 1 (vehicle malfunction), event type 2 (driver-passenger conflict), event type 3 (personal injury), coordinate of the user). For example, the information included in a help request of a user A may be (1001, male, 25, 0, [1, 0, 0], X0, Y0). The type of the event may be represented by a vector [1, 0, 0], wherein the digit 1 represents the type of the event that the user selects, and the digit 0 represents the type of the event that the user does not select. In some embodiments, when the digit is greater than 0, the larger the digit (e.g., 2, 3, 4) is, the higher a severity level of the event may be. For example, if the user A selects a second level as the severity level of the event, information of the user A may be (1001, male, 25, 0, [2, 0, 0], X0, Y0). If the user A selects a third level as the severity level of the event, the information included in the user A may be (1001, male, 25, 0, [3, 0, 0], X0, Y0). The coordinate of the user may refer to the location where the event happens. From the above examples, it may be found that the skill type of the information of the candidate service provider may correspond to the type of the event of the information included in the help request. For example, the skill 1 of the candidate service provider of the vehicle repair may correspond to the event type 1 of the vehicle malfunction. The skill 2 of the candidate service provider of the conflict mediation may correspond to the event type 2 of the driver-passenger conflict. The skill 3 of the candidate service provider of the first aid may correspond to the event type 3 of the personal injury.

Regarding the determination of the first distance, the server 110 (e.g., the first determination unit 930 of the first determination module 820 of the information processing device 800) may determine the location (X0, Y0) where the event happens and a distance S (i.e., the first distance) between each of the candidate service provider 1, the candidate service provider 2, the candidate service provider 3, the candidate service provider 4, and the candidate service provider 5, respectively, based on the location where the event happens of the first feature and the geographical location of the candidate service provider of the second feature, for example, by a latitude and longitude distance calculation formula or a two-point distance calculation formula.

For example, for the service provider 1, S1=\sqrt{(X1−X0)²+(Y1−Y0)²}.

For the service provider 2, S2=\sqrt{(X2−X0)²+(Y2−Y0)²}.

For the service provider 3, S3=\sqrt{(X3−X0)²+(Y3−Y0)²}.

For the service provider 4, S4=\sqrt{(X4−X0)²+(Y4−Y0)²}.

For the service provider 5, S5=\sqrt{(X5−X0)²+(Y5−Y0)²}.

After determining the first distance, the server 110 (e.g., the first determination unit 930 of the first determination module 820 of the information processing device 800) may determine whether the skill type of the candidate service provider matches the type of the event. The skill type of the candidate service provider matching the type of the event may refer that not only the skill of the candidate service provider corresponds to the type of the event but also the candidate service provider having the skill is able to handle the emergency. When a skill of a candidate service provider corresponds to the type of the event of the user A and a skill level of the candidate service provider is greater than or equal to a severity level of the event, the candidate service provider may be considered to match the help request of the user A. For example, if a vector of the type of the event in the help request is [1, 0, 0], a vector of the skill of a certain candidate service provider is [2, 0, 0], the skill level of the candidate service provider in the vector of the skill of the candidate service provider may be 2 greater than the severity level 1, thus the candidate service provider can handle the help request.

In some embodiments, in addition to determining whether the service provider matches the help request by comparing corresponding values in the vectors representing the type of the event of the first feature and in the vector representing skill type of the service provider of the second feature, the server 110 (e.g., the first determination unit 930 of the first determination module 820 of the information processing device 800) may also determine whether the skill of the service provider matches the type of the event, that is a matching degree between the skill type of the service provider and the type of the event, by performing a calculation on the vector representing the type of the event and the vector representing the skill type of the service provider.

For example, assuming that a vector of the skill type of the candidate service provider 1 in the first feature of the candidate service provider 1 is denoted as D1, and the vector of the information of the help request transmitted by the user A is denoted as A, the server 110 may determine a product R1 of the vector D1 and a transposed vector A^{T} of the vector A. R1=D1·A^{T}=[1,0,0]·[1,0,0]^{T}=1. Since R1 is greater than 0, the candidate service provider 1 may be determined to have the ability to handle the help request of the user A. The product of the above vectors may be the matching degree between the skill of the candidate service provider and the type of the event, that is to say, the skill of the candidate service provider corresponds to the type of the event of the emergency and the candidate service provider has the ability to handle the emergency.

Alternatively, the server 110 may determine a cosine similarity C1 of the vector D1 and the transposed vector A^{T} of the vector A according to Equation (1):

$$C 1 = \frac{D 1 * {A}^{T}}{‖ D 1 ‖ ‖ {A}^{T} ‖} \\ C 1 = \frac{[ 1 , 0 , 0 ] \cdot {[ 1 , 0 , 0 ]}^{T}}{\sqrt{{1}^{2} + {0}^{2} + {0}^{2}} \sqrt{{1}^{2} + {0}^{2} + {0}^{2}}} = 1 \qquad ( 1 )$$

Since C1 is greater than 0, the candidate service provider 1 may be determined to be able to handle the help request of the user A. Similarly, for other candidate service providers among the candidate service providers, the server 110 may determine whether other candidate service providers are able to handle the help request of the user A based on the method above. For example, in the second feature of the five candidate service providers of the candidate service provider set, the skill of the candidate service provider 2 is the conflict mediation, and the vector is represented as D2=[0, 1, 0]. Since the type of the event of the help request of the user A does not correspond to the skill of the candidate service provider 3, the candidate service provider 2 may be not suitable to handle the help request of the user A.

For example, the server 110 (e.g., the first determination unit 930 of the first determination module 820 of the information processing device 800) may determine a product R2 of the vector D2 and the transposed vector A^{T} of the vector A based on the first feature and the second feature. R2=D2·A^{T}=[0,1,0] ·[1,0,0]^{T}=0. Since R2 is equal to 0, the candidate service provider 2 may be determined to be not suitable to handle the help request of the user A.

For example, the server 110 (e.g., the first determination unit 930 of the first determination module 820 of the information processing device 800) may determine a cosine similarity C2 of the vector D2 and the transposed vector A^{T} of the vector A. C2 is equal to 0, which indicates that the candidate service provider 2 is not suitable to handle the help request of the user A.

As another example, in the second feature of the 5 candidate service providers of the candidate service provider set, the skill of the candidate service provider 3 may be the first aid, and the vector may be represented as D3=[0, 0, 1]. Since the type of the event of the help request of the user A does not correspond to the skill of the candidate service provider 3, the candidate service provider 3 may be not suitable to handle the help request of the user A.

For example, the server 110 may determine a product R3 of the vector D3 and the transposed vector A^{T} of the vector A based on the first feature and the second feature. R3=D3·A^{T}=[0,0,1]·[1,0,0]^{T}=0. Since R3 is equal to 0, the candidate service provider 3 may be determined to be not suitable to handle the help request of the user A.

For example, the server 110 (e.g., the first determination unit 930 of the first determination module 820 of the information processing device 800) may determine a cosine similarity C3 of the vector D3 and the transposed vector A^{T} of the vector A. C3 is equal to 3, which indicates that the candidate service provider 3 is not suitable to handle the help request of the user A.

As another example, in the second feature of the 5 candidate service providers of the candidate service provider set, the skill of the service provider 4 is the vehicle repair and the conflict mediation, and the vector is represented as D4=[1, 1, 0]. Since the type of the event of the help request of the user A corresponds to the skill of the candidate service provider 4, the candidate service provider 4 may have the ability to handle the help request of the user A.

For example, the server 110 may determine a product R4 of the vector D4 and the transposed vector A^{T} of the vector A based on the first feature and the second feature. R4=D4·A^{T}=[1,1,0]·[1,0,0]^{T}=1. Since R4 is greater than 0, the candidate service provider 4 may be determined to have the ability to handle the help request of the user A.

For example, the server 110 (e.g., the first determination unit 930 of the first determination module 820 of the information processing device 800) may determine a cosine similarity C4 of the vector D4 and the transposed vector A^{T} of the vector A. C4 is equal to 0, which indicates that the candidate service provider 4 is not suitable to handle the help request of the user A.

As another example, in the second feature of the 5 candidate service providers of the candidate service provider set, the skill of the candidate service provider 5 is the vehicle repair, and the vector is represented as D5=[1, 0, 0]. Since the type of the event of the help request of the user A corresponds to the skill of the candidate service provider 5, the candidate service provider 5 may have the ability to handle the help request of the user A.

For example, the server 110 may determine a product R5 of the vector D5 and the transposed vector A^{T} of the vector A based on the first feature and the second feature. R5=D5·A^{T}=[1,0,0]·[1,0,0]^{T}=1. Since R5 is greater than 0, the candidate service provider 5 may be determined to have the ability to handle the help request of the user A.

For example, the server 110 (e.g., the first determination unit 930 of the first determination module 820 of the information processing device 800) may determine a cosine similarity C5 of the vector D5 and the transposed vector A^{T} of the vector A. C5 is equal to 1, which indicates that the candidate service provider 5 has the ability to handle the help request of the user A.

In some embodiments, the server 110 (e.g., the first determination unit 930 of the first determination module 820 of the information processing device 800) may determine the first candidate service provider by comparing the first matching degree and a first threshold. In some embodiments, the first matching degree may be represented by the first distance. The server 110 (e.g., the first determination unit 930 of the first determination module 820 of the information processing device 800) may determine the first service provider by comparing the first distance and the first threshold. When the first distance is smaller than the first threshold S0, the server 110 (e.g., the first determination unit 930 of the first determination module 820 of the information processing device 800) may determine the corresponding candidate service provider as the first service provider. For example, if only S1 is smaller than the first threshold S0, the server 110 (e.g., the first determination unit 930 of the first determination module 820 of the information processing device 800) may determine the service provider 1 as the first service provider.

In another embodiment, the server 110 (e.g., the first determination unit 930 of the first determination module 820 of the information processing device 800) may determine service providers within a first range threshold from the location where the event happens based on the first feature and the second feature. Further, the server 110 (e.g., the first determination unit 930 of the first determination module 820 of the information processing device 800) may determine the first service provider, which has the ability to handle the help request of the user A, from the service providers within the first range threshold from the location where the event happens. In some embodiments, if there is no first service provider which has the ability to handle the help request of the user A and is within the first range threshold from the location where the event happens, the server 110 (e.g., the first determination unit 930 of the first determination module 80 of information processing device 800) may enlarge the first range threshold until the server 110 may determine the first service provider that has the ability to handle the help request of the user A.

In some embodiments, when there are a plurality of service providers having matched skills within the first threshold range, the server 110 (e.g., the first determination unit 930 of the first determination module 820 of the information processing device 800) may use a distance from the plurality of service providers to the location where the event happens to evaluate matching degrees of the service providers. For example, since S1<S4<S5<S0, the candidate service provider 1 may have a highest matching degree, and the server 110 (e.g., the first determination unit 930 of the first determination module 820 of the information processing device 800) may determine the candidate service provider 1 as the best service provider for handling the event of the user A.

In some embodiments, when there are a plurality of service providers having matched skills within the first range threshold, the server 110 (e.g., the first determination unit 930 of the first determination module 820 of the information processing device 800) may use a level of a candidate service provider to evaluate the matching degrees of the service providers. For example, when there are three candidate service providers having the matched skills within the first range threshold, the server 110 (e.g., the first determination unit 930 of the first determination module 820 of the information processing device 800) may determine a candidate service provider having a highest level among the service providers as the first service provider. The level of the service provider may include a skill level of the service provider (the higher the skill level is, the better handling ability may be), an assessment level of a user on the service provider (for example, an assessment of the user on the handling ability of the service provider, an assessment of the user on a service attitude of the service provider), an assessment of the server 110 on historical handling conditions of the service provider (for example, a level assessment on the candidate service provider by comprehensively considering relating information in historical handling processes of the candidate service provider).

For example, the information included in the help request of the user A may be (1001, male, 25, 0, [1, 1, 0], X0, Y0). The type of the event may be represented by a vector [1,1,0], which indicates that the user A selects the event type 1 (vehicle malfunction) and the event type 2 (driver-passenger conflict). Since the user A selects the two types of the events, preferably, the server 110 may select a candidate service provider that has the skills of the vehicle repair and the conflict mediation, for example, the candidate service provider 4. The skill of the candidate service provider 4 may correspond to a vector [1, 1, 0], which indicates that the candidate service provider 4 has the ability to handle the help request of the user A.

When the candidate service provider set does not include a service provider that has the skills of the vehicle repair and the conflict mediation, the server 110 (e.g., the first determination unit 930 of the first determination module 820 of the information processing device 800) may select one candidate service provider that has the skill of the vehicle repair and another candidate service provider that has the skill of the conflict mediation. For example, the server 110 (e.g., the first determination unit 930 of the first determination module 820 of the information processing device 800) may select the candidate service provider 1 (having the skill of the vehicle repair) and the candidate service provider 2 (having the skill of the conflict mediation). That is, for a help request including a plurality of types of events, the server 110 may select a plurality of service providers having different skills for combination, and dispatch orders to the plurality of service providers, respectively.

It should be noted that the above descriptions are provided only for illustrative purposes and not intended to limit the scope of the present disclosure. For those skilled in the art, various changes and modifications may be made in accordance with the teachings of the present disclosure. Any modification, equivalent replacement, improvement, etc. according to the spirit and principles of the present disclosure shall be included within the scope of the present disclosure.

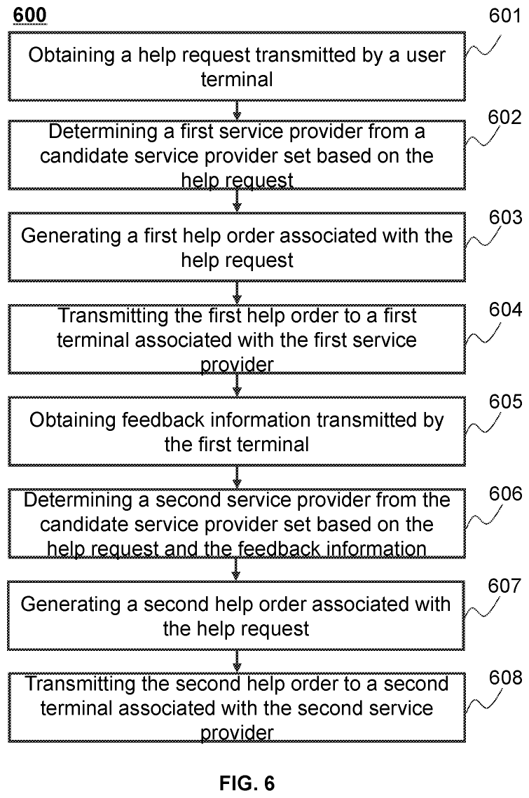

FIG. 6 is a flowchart illustrating a process for another information processing method 600 according to some embodiments of the present disclosure. In some embodiments, the information processing method 600 may be executed by the server 110 (e.g., the information processing device 1100), the computing device 200, etc., that has processing and computing capacity. For example, one or more operations in the method 600 may be stored in the storage 150 and/or the storage 220 as a form of instructions and invoked and/or executed by the server 110.

In 601, a help request transmitted by a user terminal may be obtained. Operation 601 may be executed by the first obtainment module 810.

The user terminal may include a driver terminal and/or a passenger terminal.

Operation 601 may be similar to operation 401, and detailed descriptions may be found in operation 401.

In 602, a first service provider may be determined from a candidate service provider set based on the help request. Operation 602 may be executed by the first determination module 820.

Operation 602 may be similar to operation 402, and detailed descriptions may be found in operation 402.

In 603, a first help order associated with the help request may be generated. Operation 603 may be executed by the first generation module 830.

The first help order may include at least one of a location where an event happens, a type of the event, or contact information of the user.

Operation 603 may be similar to operation 403, and detailed descriptions may be found in operation 403.

In 604, the first help order may be transmitted to a first terminal associated with the first service provider. Operation 604 may be executed by a first transmission module 840.

Operation 604 may be similar to operation 404, and detailed descriptions may be found in operation 404.

In 605, feedback information transmitted by the first terminal may be obtained. Operation 605 may be executed by a second obtainment module 850.

In some embodiments, the feedback information may include an assessment of the first service provider on the event. The server 110 (e.g., the second obtainment module 850 of the information processing device 1100) may obtain the feedback information transmit by the first service provider through the first terminal. When the first service provider arrives at a site of the event, compared to a user, the first service provider may make a more accurate assessment on the event.

For example, when a vehicle has a malfunction such as a collision, a driver or a passenger may often be injured. However, when the driver or the passenger transmits a help request, they may ignore a personal injury and often forget to select the personal injury as the type of the event. In such cases, the server 110 may need to re-dispatch a service provider having a skill of a first aid.

When such an event occurs, the user may not make an accurate assessment on a severity level of the event, and the first service provider who arrives at the site may make a more accurate assessment. For example, although the skill of the first service provider arriving at the site of the event matches the type of the event, since the user does not have the accurate assessment on the severity level of the event and a skill level of the first service provider may not match a severity level of the event, the server 110 may need to re-transmit a service provider having a higher skill level to handle the event again.

In 606, a second service provider may be determined from the candidate service provider set based on the help request and the feedback information. Operation 606 may be executed by a second determination module 860.

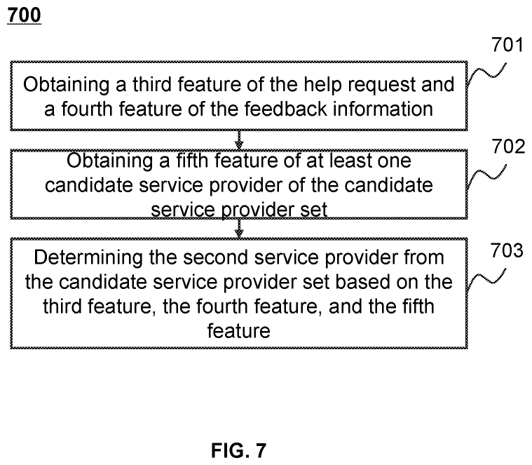

For operation 606, the present disclosure may provide an exemplary implementation. See relevant descriptions regarding FIG. 7.

In 607, a second help order may be generated. Operation 607 may be executed by a second generation module 870.

The second help order may include at least one of the location where the event happens, the type of the event, or the contact information of the user.

Operation 607 may be similar to operation 403, and detailed descriptions may be found in operation 403.

In 608, the second help order may be transmitted to a second terminal associated with the second service provider. Operation 608 may be executed by a second transmission module 880.

Operation 608 may be similar to operation 404, and detailed descriptions may be found in operation 404.

In some embodiments, the information processing method 600 may further include obtaining completing information of the help order transmitted by the user terminal. The obtainment of the completing information of the help order transmitted by the user terminal may be executed by a third obtainment module of the information processing device 1100. After the emergency is handled, the user terminal may generate the completing information of the help order based on information associated with the handling of the event, and transmit the completing information to the server 110 through the network 120. The completing information of the help order may include at least one of a time duration for handling the event or an assessment on the event. For example, after the emergency is completed, a user of the user terminal may input information associated with the handling of the event into the user terminal based on a specific process for handling the event. After receiving such information, the user terminal may generate the completing information of the help order and transmit thereof to the server 110.

It should be noted that the above descriptions are provided only for illustrative purposes and not intended to limit the scope of the present disclosure. For those skilled in the art, various changes and modifications may be made in accordance with the teachings of the present disclosure. Any modification, equivalent replacement, improvement, etc. according to the spirit and principles of the present disclosure shall be included within the scope of the present disclosure.

FIG. 7 is a flowchart illustrating a process of a method for implementing operation 606 in an information processing method according to some embodiments of the present disclosure. In some embodiments, the method 700 may be executed by the second determination module 860. As shown in FIG. 7, operation 606 may include the following operations.

In 701 a third feature of the help request and a fourth feature of the feedback information may be obtained. Operation 701 may be executed by a first obtainment unit 1210.

In some embodiments, the third feature may include a location where the event happens. The location where the event happens may include a coordinate (X0, Y0), such as a latitude coordinate, a longitude coordinate, or a map coordinate. The fourth feature may include the event and/or the assessment on the first service provider of the event, including a severity level of the event (indicating whether to continue to dispatch a service provider having a higher level of skill), a type of the event (indicating whether to dispatch a service provider having a new skill), etc. The fourth feature may be represented by a vector. For example, the vector of the fourth feature may be represented as [2, 0, 0], wherein the digit 2 represents the severity level of the event type 1 (vehicle malfunction). As another example, the vector of the third feature may be represented as [0, 1, 0], wherein the digit 1 represents a newly added event type 2 (driver-passenger conflict), and the severe level thereof is 1.

In 702, a fifth feature of each of at least one candidate service provider of the candidate service provider set may be obtained. The fifth feature may include a skill type of the candidate service provider and a geographic location of the candidate service provider. Operation 702 may be executed by the second obtainment unit 1220.

Operation 702 may be similar to operation 502, and detailed descriptions may be found in operation 502.

In 703, the second service provider may be determined from the candidate service provider set based on the third feature, the fourth feature, and the fifth feature. Operation 703 may be executed by the first determination unit 1230.

In some embodiments, the server 110 (e.g., the first determination unit 1230 of the second determination module 860 of the information processing device 1100) may first determine a second distance between a geographical location of each of at least one candidate service provider of the candidate service provider set and the location where the event happens, and determine a matching degree between the skill type of the each of at least one service provider of the candidate service provider set and the assessment of the first service provider on the event, and determine a second matching degree based on the second distance and the matching degree between the skill type and the assessment of the first service provider on the event. In response to the second matching degree smaller than a second threshold, the candidate service provider may be determined as the second service provider.

For example, assuming that the candidate service provider set includes 5 candidate service providers, and the information of a candidate service provider is represented as (ID, gender, age, telephone, skill 1 (vehicle repair), skill 2 (conflict mediation), skill 3 (first aid), location coordinate of the service provider), such as:

Candidate service provider 11 (0011, male, 30, 11, [1, 0, 0], X11, Y11);

Candidate service provider 12 (0012, male, 28, 12, [0, 1, 0], X12, Y12);

Candidate service provider 13 (0013, male, 35, 13, [0, 0, 1], X13, Y14);

Candidate service provider 14 (0014, male, 40, 14, [2, 1, 0], X14, Y14);

Candidate service provider 15 (0015, male, 26, 15, [3, 0, 0], X15, Y15).

where, the digit 1 in a vector of the skill type of the candidate service provider may represent that the candidate service provider has the skill, and the digit 0 may represent that the candidate service provider does not have the skill. When the digit is greater than 0, the larger the digit (e.g., 2, 3, 4) is, the higher the skill level of the candidate service provider may be. For example, a skill level of the vehicle repair of the candidate service provider 11 may be 1; a skill level of the vehicle repair of the candidate service provider 14 may be 2; a skill level of the vehicle repair of the candidate service provider 15 may be 3.

In addition, information included in the help request may be represented as (user ID, gender, age, telephone, event type 1 (vehicle malfunction), event type 2 (driver-passenger conflict), event type 3 (personal injury), coordinate of the user). For example, the information included in a help request of a user A may be (001, male, 25, 0, [1, 0, 0], X0, Y0). The type of the event may be represented by a vector [1, 0, 0], wherein the digit 1 represents the user selects a corresponding event type, and the digit 0 represents that the user does not select the corresponding event type. In some embodiments, when the digit is greater than 0, the larger the digit (e.g., 2, 3, 4) is, the higher a severity level of the event may be. For example, if the user A selects a second level as the severity level of the event, the information of the user A may be (001, male, 25, 0, [2, 0, 0], X0, Y0). If the user A selects a third level as the severity level of the event, the information included in the user A may be (001, male, 25, 0, [3, 0, 0], X0, Y0). The coordinate of the user may refer to a location where the event happens. From the above examples, it may be found that the skill type of the information of the candidate service provider may correspond to the type of the event of the information included in the help request. For example, the skill 1 of the candidate service provider of the vehicle repair may correspond to the event type 1 of the vehicle malfunction. The skill 2 of the candidate service provider of the conflict mediation may correspond to the event type 2 of the driver-passenger conflict. The skill 3 of the candidate service provider of the first aid may correspond to the event type 3 of the personal injury.

A vector of the fourth feature of the feedback information may be represented as F=[2, 0, 0]. That is, a feedback to the event made by the first service provider may indicate that the severity level of the vehicle malfunction is the second level. The server 110 may need to determine the second service provider that has a matched skill, a level of which is greater than or equal to the second level.

Regarding the determination of the second distance, the server 110 (e.g., the first determination unit 1230 of the second determination module 860 of the information processing device 1100) may determine a distance S (i.e., the second distance) between the location (X0, Y0) where the event happens and each of the candidate service provider 11, the candidate service provider 12, the candidate service provider 13, the candidate service provider 14, the candidate service provider 15 and, respectively, based on the location where the event happens in the third feature and the geographical location of the candidate service provider of the fifth feature, for example, by a latitude and longitude distance calculation formula or a two-point distance calculation formula.

For example,

For the candidate service provider 11, S11=\sqrt{(X11−X0)²+(Y11−Y0)²};
For the candidate service provider 12, S12=\sqrt{(X12−X0)²+(Y12−Y0)²};
For the candidate service provider 13, S13=\sqrt{(X13−X0)²+(Y13−Y0)²};
For the candidate service provider 14, S14=\sqrt{(X14−X0)²+(Y14−Y0)²};
For the candidate service provider 15, S15=\sqrt{(X15−X0)²+(Y15−Y0)²}.

After determining the second distance, the server 110 (e.g., the first determination unit 1230 of the second determination module 860 of the information processing device 1100) may determine whether the skill type of the candidate service provider matches the type of the event. The skill type of the candidate service provider matching the type of the event may refer that not only the skill of the candidate service provider corresponds to the type of the event but also the candidate service provider having the skill is able to handle the emergency. When the skill of the candidate service provider corresponds to the type of the event of the user A and a skill level of the candidate service provider is greater than or equal to the severity level of the event, the candidate service provider may be considered to match the help request of the user. A For example, if a vector of the fourth feature of the feedback information is [2, 0, 0], a vector of the skill type of a certain candidate service provider is [2, 0, 0], the skill level of the candidate service provider in the vector of the skill of the candidate service provider may be 1 less than the severity level 2, thus the candidate service provider may be not suitable to handle the help request.

In some embodiments, in addition to determining whether the candidate service provider matches the help request by comparing corresponding values in the vectors of the fourth vector and in the vector representing the skill type of the service provider of the fifth feature, the server 110 (for example, the first determination unit 1230 of the second determination module 860 of the information processing device 1100) may also determine whether the skill of the candidate service provider matches the type of the event, that is a matching degree between the skill type of the service provider and the type of the event, by performing a calculation on the vector of the fifth feature and the vector representing the skill type of the candidate service provider in the second feature.

For example, assuming that a vector of the fourth feature is F=[2, 0, 0], and in the fifth feature of the 5 candidate service providers of the candidate service provider set, a vector of a skill type of the candidate service provider 11 is denoted as D11, the server 110 may determine a product R11 of the vector D11 and a transposed vector FT of the vector F.

Further, the server 110 (e.g., the first determination unit 1230 of the second determination module 860 of the information processing device 1100) may compare the skill level of the candidate service provider and the severity level of the event. The skill level is 1 smaller than the severity level of the event of 2, which indicates that the service provider 11 is not suitable to handle the help request of the user A.

For example, in the fifth feature of the 5 service providers of the candidate service provider set, the skill of the candidate service provider 12 is the conflict mediation, and the vector is represented as D12=[0, 1, 0]. Since the type of the event of the feedback information of the first service provider does not correspond to the skill of the service provider 1, the service provider 12 may be not suitable to handle the help request of the user A.

For example, the server 110 (e.g., the first determination unit 1230 of the second determination module 860 of the information processing device 1100) may determine a product R12 of the vector D12 and the transposed vector F^{T} of the vector F based on the fourth feature and the fifth feature. R12=D12·F^{T}=[0,1,0]·[2,0,0]^{T}=0. Since R12 is equal to 0, the candidate service provider 12 may be determined to be not suitable to handle the help request of the user A.

As another example, in the fifth feature of the 5 service providers of the candidate service provider set, the skill of the candidate service provider 13 may be the first aid, and the vector may be represented as D13=[0, 0, 1]. Since the type of the event of the help request of the user A does not correspond to the skill of the candidate service provider 13, the candidate service provider 13 may be not suitable to handle the help request of the user A.

For example, the server 110 (e.g., the first determination unit 1230 of the second determination module 860 of the information processing device 1100) may determine a product R13 of a vector D13 and the transposed vector F^{T} of the vector F based on the fourth feature and the fifth feature. R13=D13·F^{T}=[0,0,1]·[2,0,0]^{T}=0. Since R13 is equal to 0, t the candidate service provider 13 may be determined to be not suitable to handle the help request of the user A.

As another example, in the fifth feature of the 5 service providers of the candidate service provider set, the skill of the candidate service provider 14 may be the vehicle repair, and the vector may be represented as D14=[2, 1, 0]. Since the type of the event of the help request of the user A corresponds to the skill of the candidate service provider 14, the candidate service provider 14 may have the ability to handle the help request of the user A.

For example, the server 110 (e.g., the first determination unit 1230 of the second determination module 860 of the information processing device 1100) may determine a product R14 of the vector D14 and the transposed vector F^{T} of the vector F based on the fourth feature and the fifth feature. R14=D14·F^{T}=[2,1,0]·[2,0,0]^{T}=4. R14 may be greater than 0.

Further, the server 110 (e.g., the first determination unit 1230 of the second determination module 860 of the information processing device 1100) may compare the skill level and the severity level, and the skill level of 2 is the same as the severity level of 2, which indicates that the candidate service provider 14 has the ability to handle the help request of the user A.

As another example, in the fifth feature of the 5 service providers of the candidate service provider, the skill of the candidate service provider 15 may be the vehicle repair, and the vector may be represented as D15=[3, 0, 0]. Since the type of the event of the feedback information of the user corresponds to the skill of the candidate service provider 14, the candidate service provider 14 may have the ability to handle the help request of the user A.

For example, the server 110 (e.g., the first determination unit 1230 of the second determination module 860 of the information processing device 1100) may determine a product R15 of the vector D15 and the transposed vector F^{T} of the vector F based on the fourth feature and the fifth feature. R15=D15·F^{T}=[3,0,0]·[2,0,0]^{T}=6. R15 may be greater than 0.

Further, the server 110 (e.g., the first determination unit 1230 of the second determination module 860 of the information processing device 1100) may compare the skill level and the severity level of the event, the skill level of 3 is larger than the severity level of the event of 2, which indicates that the candidate service provider 15 has the ability to handle the help request of the user A.

In the present embodiment, the server 110 (e.g., the first determination unit 1230 of the second determination module 860 of the information processing device 1100) may determine a second service provider that is able to handle the help request of the user A based on the third feature, fourth feature, and fifth feature. The second matching degree may be represented by the second distance. When the second distance is smaller than a first threshold S0, the server 110 (e.g., the first determination unit 1230 of the second determination module 860 of the information processing device 1100) may determine the corresponding service provider as the second service provider. For example, if only S11 is smaller than the first threshold S0, the server 110 (e.g., the first determination unit 1230 of the second determination module 860 of the information processing device 1100) may determine the service provider 11 as the second service provider.

In another embodiment, the server 110 (e.g., the first determination unit 1230 of the second determination module 860 of the information processing device 1100) may determine service providers within a second threshold range from the location where the event happens based on the second distance. Further, the server 110 (e.g., the first determination unit 1230 of the second determination module 860 of the information processing device 1100) may determine the second service provider having the ability to handle the help request of the user A, from the service providers within the second threshold range from the location where the event happens, based on a matching degree between the skill type and the assessment on the event.

In some embodiments, when there is no second candidate service provider that is able to handle the help request of the user A and is within the first range threshold from the location where the event happens, the server 110 (e.g., the second determination module 860 of the information processing device 1100) may enlarge the first range threshold until the server 110 may determine the second service provider that has the ability to handle the help request of the user A.

In some embodiments, when there are a plurality of service providers having a matched skill within the first threshold range, the server 110 may use a distance from the plurality of service providers to the location where the event happens to evaluate matching degrees of the service providers. For example, since S11<S14<S15<S0, the candidate service provider 11 may have a highest matching degree, and the server 110 (e.g., the first determination unit 1230 of the second determination module 860 of the information processing device 1100) may determine the candidate service provider 11 as the best service provider for handling the event of the user A.

In some embodiments, when there are a plurality of service providers who have matched skills within the first threshold range, the server 110 may use a level of a candidate service provider to evaluate the matching degrees of the service providers. For example, when there are three candidate service providers having the matched skills within the first threshold range, the server 110 (e.g., the first determination unit 1230 of the second determination module 860 of the information processing device 1100) may determine a candidate service provider having a highest level among the service providers as the first service provider. The level of the service provider may include a skill level of the service provider (the higher the skill level is, the better handling ability may be), an assessment level of a user on the service provider (for example, an assessment of the user on the handling ability of the service provider, an assessment of the user on a service attitude of the service provider), and an assessment of the server 110 on historical handling conditions of the service provider (for example, a level assessment on a candidate service provider by comprehensively considering relating information in historical handling processes of the candidate service provider). For example, since S11<S14<S15<S0, the candidate service provider 15 has a highest skill level, and the candidate service provider 5 may have a highest matching degree. The server 110 (e.g., the first determination unit 1230 of the second determination module 860 of the information processing device 1100) may determine the candidate service provider 15 as the best service provider for handling the event of the user A.

It should be noted that the above descriptions are provided only for illustrative purposes and not intended to limit the scope of the present disclosure. For those skilled in the art, various changes and modifications may be made in accordance with the teachings of the present disclosure. Any modification, equivalent replacement, improvement, etc. according to the spirit and principles of the present disclosure shall be included within the scope of the present disclosure.

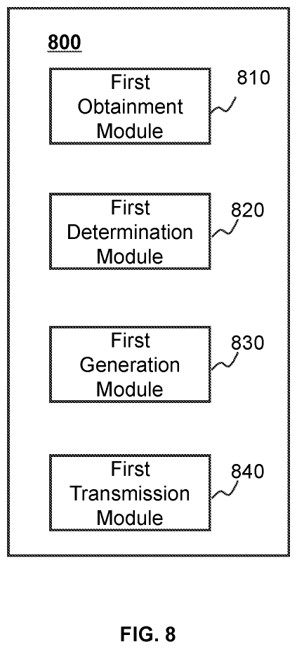

FIG. 8 is a functional block diagram illustrating an information processing device 800 according to some embodiments of the present disclosure.

The information processing device 800 may include a first obtainment module 810, a first determination module 820, a first generation module 830, and a first transmission module 840.

The first obtainment module 810 may be configured to obtain a help request transmitted by a user terminal. The help request may be in response to an event associated with a user. The user terminal may include a driver terminal and/or a passenger terminal.

The first determination module 820 may be configured to determine a first service provider from a candidate service provider set based on the help request. The first service provider may have the ability to arrive at a location where the event happens within a preset time period and handle the event.

The first generation module 830 may be configured to generate a first help order associated with the help request. The first help order may include at least one of the location where the event happens, a type of the event, or contact information of the user.

The first transmission module 840 may be configured to transmit the first help order to a first terminal associated with the first service provider.

In some embodiments, the information processing device 110 may further include a second obtainment module configured to obtain completing information of the help order transmitted by the user terminal. The completing information of the help order may include at least one of a time duration for handling the event or an assessment on the event.

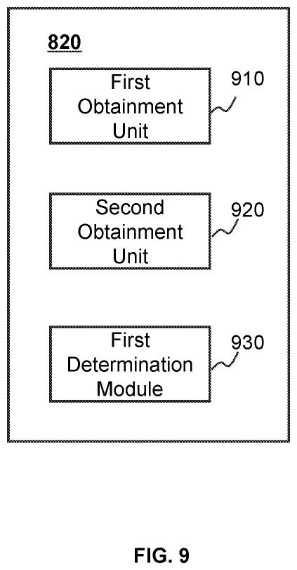

FIG. 9 is a functional block diagram illustrating a first determination module 820 according to some embodiments of the present disclosure.

The first determination module 820 may include a first obtainment unit 910, a second obtainment unit 920, and a first determination unit 930.

The first obtainment unit 910 may be configured to obtain a first feature of the help request. The first feature of the help request may include at least one of the location where the event happens, the type of the event, or a time when the event happens.

The second obtainment unit 920 may be configured to obtain a second feature of each of at least one candidate service provider of the candidate service provider set. The second feature may include at least one of a skill type or a geographic location of each of at least one candidate service provider.

The first determination unit 930 may be configured to determine a first matching degree between each of at least one candidate service provider of the candidate service provider set and the help request based on the first feature and the second feature, and determine the first service provider from the candidate service provider set based on the first matching degree.

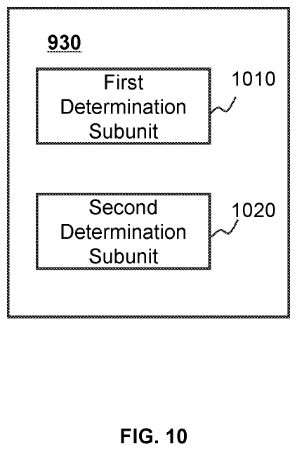

FIG. 10 is a functional block diagram illustrating a first determination unit 930 according to some embodiments of the present disclosure.

The first determination unit 930 may include a first determination subunit 1010 and a second determination subunit 1020.

The first determination subunit 1010 may be configured to determine a first distance between the geographic location of each of at least one candidate service provider of the candidate service provider set and the location where the event happens, determine a matching degree between the skill type of each of at least one candidate service provider of the candidate service provider set and the type of the event, and determine the first matching degree based on the first distance and the matching degree between the skill type and the type of the event.

The second determination subunit 1020 may be configured to in response to the first matching degree of one of the at least one candidate service provider smaller than a first threshold, determine the candidate service provider as the first service provider.

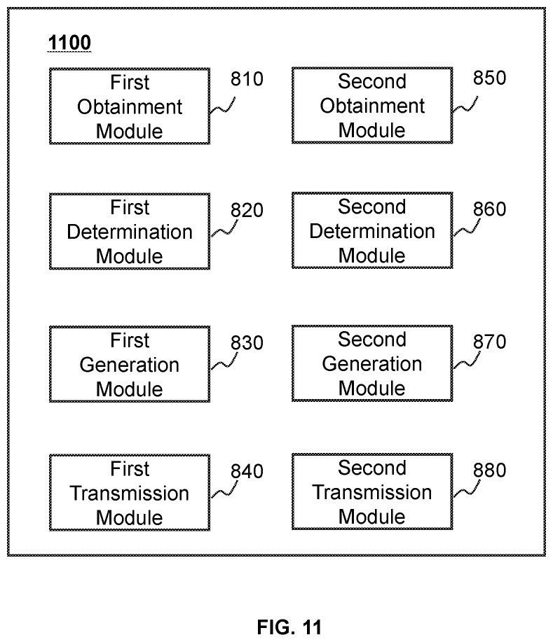

FIG. 11 is a functional block diagram illustrating another information processing device 1100 according to some embodiments of the present disclosure.

The information processing device 1100 may include a first obtainment module 810, a first determination module 820, a first generation module 830, a first transmission module 840, a second obtainment module 850, a second determination module 860, a second generation module 870, and a second transmission module 880.

The first obtainment module 810 may be configured to obtain a help request transmitted by a user terminal. The user terminal may include a driver terminal and/or a passenger terminal.

The first determination module 820 may be configured to determine a first service provider from a candidate service provider set based on the help request.

The first generation module 830 may be configured to generate a first help order. The first help order may include at least one of a location where an event happens, a type of the event, or contact information of the user.

The first transmission module 840 may be configured to transmit the first help order to a first terminal associated with the first service provider.

The second obtainment module 850 may be configured to obtain feedback information transmitted by the first terminal. The feedback information may include an assessment of the first service provider on the event.

The second determination module 860 may be configured to determine a second service provider from the candidate service provider set based on the help request and the feedback information.

The second generation module 870 may be configured to generate a second help order associated with the help request. The second help order may include at least one of the location where the event happens, the type of the event, or the contact information of the user.

The second transmission module 880 may be configured to transmit the second help order to a second terminal associated with the second service provider.

In some embodiments, the information processing device 1100 may further include a third obtainment module configured to obtain completing information of the help order transmitted by the user terminal. The completing information of the help order may include at least one of a time duration for handling the event or an assessment on the event.

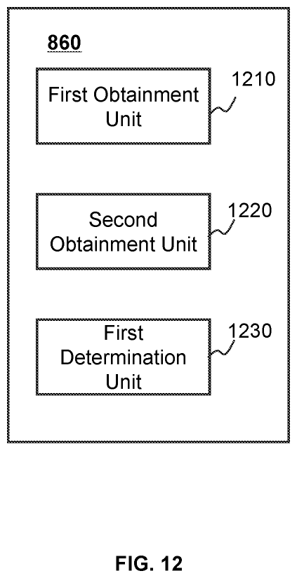

FIG. 12 is a functional block diagram illustrating a second determination module 860 according to some embodiments of the present disclosure.

The second determination module 860 may include a first obtainment unit 1210, a second obtainment unit 1220, and a first determination unit 1230.

The first obtainment unit 1210 may be configured to obtain a third feature of the help request and a fourth feature of the feedback information. The first feature may include the location where the event happens. The third feature may include the assessment of the first service provider on the event.

The second obtainment unit 1220 may be configured to obtain a fifth feature of each of at least one candidate service provider of the candidate service provider set. The fifth feature may include a skill type and a geographical location of each of at least one candidate service provider.

The first determination unit 1230 may be configured to determine the second service provider from the candidate service provider set based on the third feature, the fourth feature, and the fifth feature.

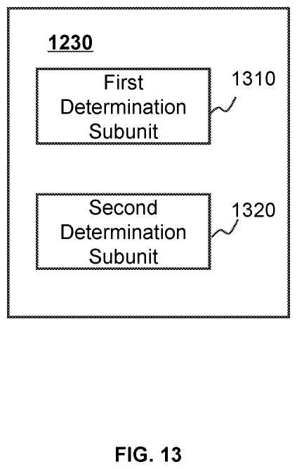

FIG. 13 is a functional block diagram illustrating a second determination module 1230 according to some embodiments of the present disclosure.

The second determination module 1230 may include a first determination subunit 1310 and a second determination subunit 1320.

The first determination subunit 1310 may be configured to determine a second distance between the geographical location of each of at least one candidate service provider of the candidate service provider and the location where the event happens, determine a matching degree between the skill type of each of at least one service provider of the candidate service provider set and the assessment of the first service provider on the event, and determine a second matching degree based on the second distance and the matching degree between the skill type and the assessment of the first service provider on the event.

The second determination subunit 1320 may be configured to in response to the second matching degree of one of the at least one candidate service provider of the candidate service provider set smaller than a second threshold, determine the candidate service provider as a second service provider.

The abovementioned devices, modules, and units, may be refer to FIG. 4 to FIG. 7 of the present disclosure.

The various modules and units (FIG. 8 to FIG. 13) described above are not necessary, and those skilled in the art, after understanding the content and principal of the present disclosure, may make various modifications and changes in the form and details of the system, without departing from the principal and the structure of the present technique. Each module may be arbitrarily combined, or a subsystem is connected to other modules, and these modifications and changes are still in the scope of the claims of the present disclosure.

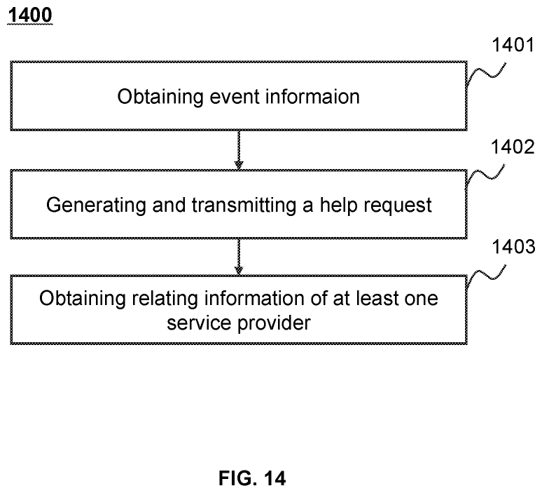

FIG. 14 is a flowchart illustrating a process for another information processing method 1400 according to some embodiments of the present disclosure. In some embodiments, the information processing method 1400 may be executed by the service request terminal 130, the service providing end 140, the mobile device 300 (e.g., the information processing device 1500), etc., that has processing and computing capacity. For example, one or more operations in the method 1400 may be stored in the storage 150 and/or the storage 220 as a form of instructions and invoked and/or executed by the server 110. As shown in FIG. 14, the method 1400 may include the following operations.

In 1401, event information may be obtained. Operation 1401 may be executed by a second obtainment module 1510.

In some embodiments, a user terminal (including the service request terminal 130 and/or the service providing end 140, or the first obtainment module 1510 of the information processing device 1500) may acquire the event information input by a user. The event information inputted by the user may include a speech form, a text form, an image form, a video form, or the like, or a combination thereof.

In 1402, a help request may be generated and transmitted. The help request may include at least of a type of an event and a location where the event happens. Operation 1402 may be executed by a third generation module 1520.

In some embodiments, the user terminal (or the third generation module 1520 of the information processing device 1500) may generate a help request based on the event information. Further, the user terminal (or the third generation module 1520 of the information processing device 1500) may transmit the help request to the server 110.

In 1403, relating information of at least one service provider may be obtained. The relating information of a service provider may at least include contact information and a location of the service provider. Operation 1403 may be executed by a third obtainment module 1530.

In some embodiments, the user terminal (or the third obtainment module 1530 of the information processing device 1500) may obtain the relating information of the at least one service provider transmitted by the server 110. The user may know that the relating information of the service provider may include the contact information of the service provider and the location of the service provider.

In some embodiments, the information processing method may further may include: transmitting completing information of a help order. The completing information of the help order may include at least one of a time duration for handling the event or an assessment on the event.

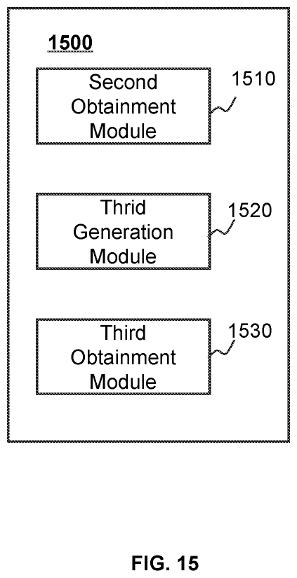

FIG. 15 is a functional block diagram illustrating another information processing device 1500 according to some embodiments of the present disclosure.

The information processing apparatus 1500 may be implemented by a user terminal (e.g., the service request terminal 130 and/or the service provider 140). The information processing device 1500 may include a first obtainment module 1510, a generation module 1520, and a second obtainment module 1530.

The first obtainment module 1510 may be configured to obtain event information.

The third generation module 1520 may be configured to generate and transmit a help request. The help request may include at least one of a type of an event and a location where the event happens.

The third obtainment module 1530 may be configured to obtain relating information of at least one service provider. The relating information of a service provider may at least include contact information and a location of the service provider.

In some embodiments, the information processing device 1500 may further include a transmission module for transmitting completing information of a help order. The completing information of the help order may include at least one of a time duration for handling the event or an assessment on the event.

The description regarding the above device and the modules may be referred to FIG. 14 of the present disclosure.

It should be noted that the various modules described above may be a software module implemented by a computing instruction.

The various modules and units described above are not necessary. Those skilled in the art, after understanding the content and principle of this application, may make various modifications and changes in the form and details of the system without deviating from the technical principle and structure.

The beneficial effects brought by embodiments of the present disclosure may include, but be not limited to: (1) improving the accuracy and the efficiency of dispatching rescue orders by dispatching the rescue orders online; (2) handling the rescue orders more accurately through dispatching serial rescue orders by obtaining feedback information of the service provider and reducing human labor cost. It should be noted that the beneficial effects of different embodiments may be different. The beneficial effects brought by different embodiments may be any one or more of the above, or any other beneficial effect may be obtained.

Those skilled in the art will appreciate that embodiments of the present disclosure can be provided as a method, system, or computer program product. Accordingly, the present disclosure may use a full hardware embodiment, a fully software embodiment or a combination of software and hardware embodiments. Moreover, the present disclosure may employ a computer program product that includes a computer available storage medium (including but be not limited to a disk memory, a CD-ROM, an optical memory, etc.) implemented in one or more computers.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure.

In addition, the embodiments in the present disclosure may involve some new processes, methods, machines, products, or improvements associated therewith. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

1-32. (canceled)

33. An information processing system comprising:
at least one storage device including a set of instructions; and
at least one processor in communication with the at least one storage device, wherein when executing the set of instructions, the at least one processor is configured to cause the system to:
obtain a help request transmitted by a user terminal through an online to offline service platform implemented on the user terminal, the help request being in response to an event associated with a user;
determine a first service provider from a candidate service provider set based on the help request, the first service provider having an ability to arrive at a location where the event happens within a preset time period and handle the event;
generate a first help order associated with the help request; and
transmit the first help order to a first terminal associated with the first service provider through the online to offline service platform implemented on the first terminal via the network.

34. The system of claim 33, wherein the user terminal includes a driver terminal or a passenger terminal.

35. The system of claim 33, wherein the first help order includes at least one of the location where the event happens, a type of the event, or contact information of the user.

36. The system of claim 33, wherein to determine a first service provider from a candidate service provider set based on the help request, the at least one processor is configured to cause the system to:
obtain a first feature of the help request;
obtain a second feature of each of at least one candidate service provider of the candidate service provider set;
determine a first matching degree between the each of the at least one candidate service provider of the candidate service provider set and the help request based on the first feature and the second feature; and
determine the first service provider from the candidate service provider set based on the first matching degree.

37. The system of claim 36, wherein the first feature of the help request includes at least one of the location where the event happens, a type of the event, or a time when the event happens.

38. The system of claim 37, wherein the second feature includes at least one of a skill type or a geographic location of the each of the at least one candidate service provider.

39. The system of claim 38, wherein to determine a first matching degree between the each of the at least one candidate service provider of the candidate service provider set and the help request based on the first feature and the second feature, the at least one processor is configured to cause the system to:
determine a first distance between the geographic location of the each of the at least one candidate service provider of the candidate service provider set and the location where the event happens;
determine a matching degree between the skill type of the each of the at least one candidate service provider of the candidate service provider set and the type of the event; and
determine the first matching degree based on the first distance and the matching degree between the skill type and the type of the event.

40. The system of claim 39, wherein to determine the first service provider from the candidate service provider set based on the first matching degree, the at least one processor is configured to cause the system to:
in response to the first matching degree of one of the at least one candidate service provider smaller than a first threshold, determine the one of the at least one candidate service provider as the first service provider.

41. The system of claim 33, wherein the at least one processor is configured to cause the system further to:
obtain feedback information transmitted by the first terminal, the feedback information including an assessment of the first service provider on the event;
determine a second service provider from the candidate service provider set based on the help request and the feedback information;
generate a second help order associated with the help request, the second help order including at least one of the location where the event happens, a type of the event, or contact information of the user; and
transmit the second help order to a second terminal associated with the second service provider.

42. The system of claim 41, wherein to determine a second service provider from the candidate service provider set based on the help request and the feedback information, the at least one processor is configured to cause the system to:
obtain a third feature of the help request and a fourth feature of the feedback information, the third feature including the location where the event happens, the fourth feature including the assessment of the first service provider on the event;
obtain a fifth feature of each of at least one candidate service provider of the candidate service provider set, the fifth feature including a skill type and a geographical location of the each of at least one candidate service provider; and
determine the second service provider from the candidate service provider set based on the third feature, the fourth feature, and the fifth feature.

43. The system of claim 42, wherein to determine the second service provider from the candidate service provider set based on the third feature, the fourth feature, and the fifth feature, the at least one processor is configured to cause the system to:
determine a second distance between the geographical location of the each of the at least one candidate service provider of the candidate service provider set and the location where the event happens;
determine a matching degree between the skill type of the each of the at least one candidate service provider of the candidate service provider set and the assessment of the first service provider on the event;
determine a second matching degree based on the second distance and the matching degree between the skill type and the assessment of the first service provider on the event; and
in response to the second matching degree of one of the at least one candidate service provider of the candidate service provider set smaller than a second threshold, determine the one of the at least one candidate service provider as the second service provider.

44. The system of claim 33, wherein the at least one processor is configured to cause the system further to:
obtain completing information of the help order transmitted by the user terminal, wherein the completing information of the help order includes at least one of a time duration for handling the event or an assessment on the event.

45. An information processing method comprising:
obtaining a help request transmitted by a user terminal through an online to offline service platform implemented on the user terminal, the help request being in response to an event associated with a user;
determining a first service provider from a candidate service provider set based on the help request, the first service provider having an ability to arrive at a location where the event happens within a preset time period and handle the event;
generating a first help order associated with the help request; and
transmitting the first help order to a first terminal associated with the first service provider through the online to offline service platform implemented on the first terminal via the network.

46. The method of claim 45, wherein the first help order includes at least one of the location where the event happens, a type of the event, or contact information of the user.

47. The method of claim 45, wherein the determining a first service provider from a candidate service provider set based on the help request includes:
obtaining a first feature of the help request;
obtaining a second feature of each of at least one candidate service provider of the candidate service provider set;
determining a first matching degree between the each of the at least one candidate service provider of the candidate service provider set and the help request based on the first feature and the second feature; and
determining the first service provider from the candidate service provider set based on the first matching degree.

48. The method of claim 47, wherein the first feature of the help request includes at least one of the location where the event happens, a type of the event, or a time when the event happens.

49. The method of claim 48, wherein the second feature includes at least one of a skill type and a geographic location of the at least one candidate service provider.

50. The method of claim 49, wherein the determining a first matching degree between the each of the at least one candidate service provider of the candidate service provider set and the help request based on the first feature and the second feature includes:
determining a first distance between the geographic location of the each of the at least one candidate service provider of the candidate service provider set and the location where the event happens;
determining a matching degree between the skill type of the each of the at least one candidate service provider of the candidate service provider set and the type of the event; and
determining the first matching degree based on the first distance and the matching degree between the skill type and the type of the event.

51. The method of claim 50, wherein the determining the first service provider from the candidate service provider set based on the first matching degree includes:
in response to the first matching degree of one of the at least one candidate service provider smaller than a first threshold, determining the one of the at least one candidate service provider as the first service provider.

52. A computer-readable storage medium, wherein the storage medium includes computing instructions for information processing, when executed, the computing instructions direct a system to perform a method, the method comprises:
obtaining a help request transmitted by a user terminal through an online to offline service platform implemented on the user terminal, the help request being in response to an event associated with a user;
determining a first service provider from a candidate service provider set based on the help request, the first service provider having an ability to arrive at a location where the event happens within a preset time period and handle the event;
generating a first help order associated with the help request; and
transmitting the first help order to a first terminal associated with the first service provider through the online to offline service platform implemented on the first terminal via the network.
